(19) United States
(12) Patent Application Publication
(10) Pub. No.: US 2012/0196012 A1
(43) Pub. Date: Aug. 2, 2012

(54) Adjustable Seasoning Distribution Tube

(75) Inventors: Rudolph L. Bazaldua, Midlothian, TX (US); Lee Brady, Corning, NY (US)

(73) Assignee: FRITO-LAY NORTH AMERICA, INC., Plano, TX (US)

(21) Appl. No.: 13/017,831

(22) Filed: Jan. 31, 2011

(51) Int. Cl. A23P 1/08

(52) U.S. Cl. 426/289; 118/13

(57) ABSTRACT

An apparatus and method for providing a controlled, uniform distribution of seasoning onto snack food products such as potato chips or tortilla chips using an adjustable, segmented seasoning distribution tube adaptable to an existing product line. The tube comprises a base member attached at one end to the delivery device of the seasoning distribution system and at least two segments attached in succession to the base member. Each segment has an opening along the length of the segment, which may be adjusted above or below the longitudinal axis of the tube.

### BACKGROUND OF THE INVENTION

1. Technical Field

This invention relates to improvements in a method and apparatus for the distribution of seasonings, e.g., seasonings as placed on potato chips, corn chips, and like snack foods and more particularly, to a method and apparatus that permits uniform distribution of different seasoning materials during the manufacture of snack food items.

2. Description of Related Art

Snack food products, particularly seasoned snacks, are popular snack choices with consumers. For example, tortilla chips, pretzels, crackers, popcorn, and numerous other foodstuffs often have seasonings applied to them during processing. To season, snack food products are typically seasoned by sprinkling one or more seasonings onto the surface of the snack food products. Seasonings used, usually in a powdered form, have included salt, cheese, chili, garlic, Cajun spice, ranch, sour cream and onion, among many others.

FIG. 1 is a schematic sectional elevation view of a prior art seasoning distribution system. FIG. 2 is a schematic sectional view taken along line 2-2 of FIG. 1. Referring to FIGS. 1 and 2, the apparatus 10 generally comprises a cylindrical drum 14 and a non-rotating horizontal seasoning dispenser. Unseasoned snack food 12 enters a cylindrical drum 14 at one end through a funnel 16. Drum 14 is tilted slightly at an angle of about 5 degrees and is axially rotated in the direction indicated by arrow 18. The speed of rotation is generally between 4 and 15 RPM. The combination of tilt and rotation causes the snack food to travel continuously down the drum to exit 20. Baffles 21 may be positioned radially on the drum perimeter to aid in mixing the snack food. A horizontal, non-rotating seasoning dispenser 22 has a tube portion 24 extending into the drum. Within the tube 24 is an auger 26 in close tolerance with the tube inner wall. The auger is rotated by a power source 28 such as an electric motor. This tumbling drum arrangement and the application in general of seasoning falling from a tube to snack food therein is well known and conventional in the art. Seasoning 30, such as barbeque, sour cream, etc., is fed to the dispenser via a hopper 32 and is conveyed along the tube 24 by the auger 26. A series of apertures in the bottom of the far end of the tube 24, opposite the hopper 32, allows the seasoning to drop by gravity onto the snack food. As indicated by arrows, the seasoning is distributed in the form of a dispersion “curtain”.

The seasoning dispenser 22 may be positioned offset from the cross-sectional center of the drum, as shown in FIG. 2, in order to distribute the seasoning over the location of maximum concentration of snack food. Because of the drum rotation, the snack food tends to migrate up the drum wall, and thus the maximum concentration is located at a point other than the lowest portion of the drum. The optimum position for the dispenser is, of course, dictated by the degree of migration of the snack food, which in turn is dependent on the speed of rotation and tilt angle of the drum, and the size and number of baffles along the drum perimeter. Those skilled in the art can readily ascertain the proper location for the dispenser based upon a given set of the above process parameters.

Several factors affect product quality. One such factor is the application and distribution of the seasoning onto the snacks is a factor in product quality. If the seasoning is deposited onto the snacks in clumps some snacks receive excessive amounts of the desired quantity of seasoning while others receive less than desired amounts of seasoning. Basically, the overall quality of the snacks will be poor if the seasoning is applied too clumpy. In addition to the aesthetic aspects of seasoning distribution, economics suffer if the seasoning is applied inefficiently. Also, achieving the optimum compromise between uniform seasoning coverage of the snack product along with minimum product breakage requires careful selection of tumbler drum size. A longer tumbler drum can result in higher, undesirable product breakage.

One problem with this prior art apparatus is the uneven distribution of seasoning over the bed of product. As the seasoning is conveyed along the tube by the auger, seasoning falls onto the product bed through the slot in the tube. However, the amount of seasoning that is dispensed along the slot cannot be controlled and results in more seasoning being dispersed at some points along the slot than others. Further, a high amount of seasoning is dispensed through the end of the tube rather than through the slot, which results in a loss of seasoning during the process. This problem is compounded by the fact that different seasonings have different flowabilities, so that the optimum amount of seasoning fed into the tube and the speed of the auger vary with each type of seasoning. Another problem arises when multiple tumbler drums are used to season a product. When the product is diverted to different tumblers from the cooking step, the resulting seasoned products have different amounts of seasoning applied.

Consequently a need exists for an apparatus that can provide a controlled, uniform seasoning coverage onto snack products for different types of seasonings while minimizing product breakage. The method and apparatus should be adaptable to an existing product line where seasoning is applied to a snack food substrate. In addition, the apparatus should not result in an increase in product breakage. Thereby snack products with uniform layered seasoning coverage can be produced in an economical manner while avoiding product breakage.

### SUMMARY OF THE INVENTION

The invention relates to a method and apparatus for the controlled, uniform distribution of seasoning upon a snack food product. In one aspect, the invention comprises an adjustable, segmented seasoning distribution tube that may be used in conjunction with a rotating drum having a snack food product. A tubular base member is attached at one end to the delivery device of the seasoning distribution system. At least two segments are attached in succession to the base member to form the generally horizontal seasoning tube. The number and length of the segments may be determined by one skilled in the art. Each segment has an opening along its length to allow distribution of the seasoning material as the seasoning material travels down the tube. The vertical position of the opening may be adjusted above or below the longitudinal axis of the tube to achieve uniform seasoning distribution and accommodate different seasonings.

Hence, this invention produces a method and apparatus whereby seasonings can be uniformly distributed upon a snack food product to achieve a snack food product having uniform coverage while minimizing the loss of seasoning. The above as well as additional features and advantages of the present invention will become apparent in the following written

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic sectional elevation view of a prior art seasoning distribution system.

FIG. 2 is a schematic sectional view taken along line 2-2 of FIG. 1.

FIG. 3 is a schematic sectional elevation view of one embodiment of the seasoning distribution tube in accordance with one embodiment of the present invention.

FIG. 4 is a schematic sectional elevation view of one embodiment of the seasoning distribution tube in accordance with one embodiment of the present invention.

FIG. 5 is a graph comparing the amounts of seasoning distributed by a prior art seasoning distribution tube and the inventive seasoning distribution tube.

FIG. 6 is a graph showing the product coverage of a prior art seasoning distribution tube at 2378 pounds of seasoning per hour.

FIG. 7 is a graph showing the product coverage of the inventive seasoning distribution tube at 2378 pounds of seasoning per hour.

FIG. 8 is a graph showing the product coverage of a prior art seasoning distribution tube at 1700 pounds of seasoning per hour.

FIG. 9 is a graph showing the product coverage of the inventive seasoning distribution tube at 1700 pounds of seasoning per hour.

### DETAILED DESCRIPTION

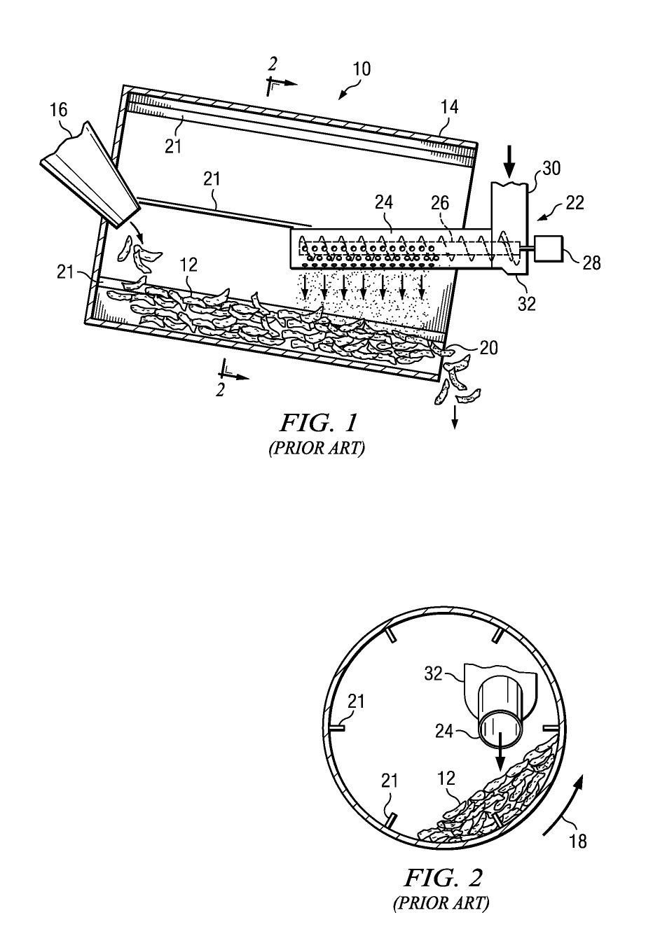

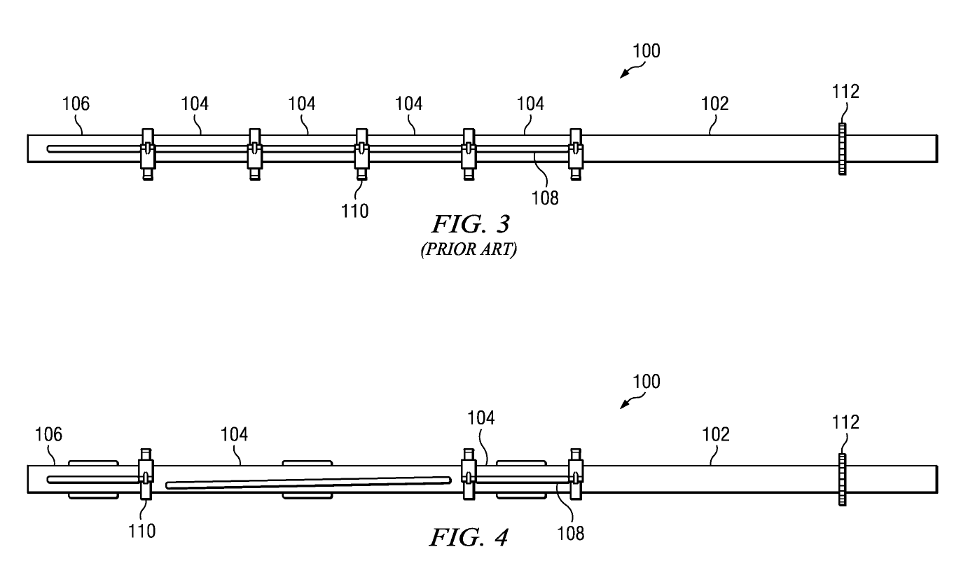

The present invention is an improved adjustable seasoning distribution tube for use in an existing product line, preferably a tumbler seasoning distribution system as depicted in FIG. 1. Referring to FIG. 3, the tube 100 is comprised of a base member 102 attached at one end to a seasoning delivery device (not shown) of the seasoning distribution system, such that the tube 100 and the delivery device are in fluid communication. Attached in succession to the base member 102 are at least two segments 104 to form the generally horizontal tube 100. As used herein, segment means an individual section of the overall tube from which seasoning is dispensed. The segments 104 may be of equal length or unequal length. The tube 100 may terminate in a terminal segment 106 attached to the segment 104 distal from the base member 102. The terminal segment 106 is open at its unattached end to allow seasoning to be dispensed. The tube 100 may have a length of about 30 inches to about 100 inches and a diameter of about 0.5 inches to about 3 inches. In one embodiment, the tube 100 has a length of about 56.75 inches and a diameter of about 1.75 inches. In another embodiment, the tube 100 has a length of about 79 inches and a diameter of about 1.75 inches. One skilled in the art may determine the length of the tube, the number of segments and the length of each segment to best suit the needs of the particular product line and the seasoning used.

Each of the segments 104 and the terminal segment 106 has an opening along the length of one side of the segment. In one embodiment, the opening is an elongated slot 108, which allows seasoning to be dispersed as it travels down the seasoning tube 100, but the opening may be any shape that accomplishes the purpose of the invention. When Applicants refer to a slot or dispensing slot, it should be read as any opening that accomplishes the purpose of the invention. The slot 108 may be cut along the longitudinal axis of the tube 100 or may be offset from the longitudinal axis of the tube 100 at an angle. The length, width and optimal of the angle of the slot 108 for each segment 104, 106 may be determined by one skilled in the art according to the particular product line and seasoning used. Preferably the length of the slot 108 is maximized in proportion to the length of the sections 104, 106. In one embodiment, the slot 108 of the terminal segment 106 terminates about 0.5 inches to 2 inches from the end of the segment to allow for support for the tube 100 to be attached. Support for the tube 100 may also be placed on the base member 102 or segments 104 as necessary. In one embodiment, the slot 108 has a width of about 0.1 inches to about 1 inches, preferably about 0.3125 inches. An auger (not shown) may be inserted into the seasoning tube 100 to convey the seasoning down the tube from the delivery device.

The base member 102, segments 104, and terminal segment 106 may be coupled together by any means known in the art. In one embodiment, sanitary gasket-less clamps 110 are used to minimize cleaning Each segment 104 and terminal segment 106 may be rotated such that the vertical position of the dispensing slot 108 is located above or below the longitudinal axis of the tube 100. This adjustability allows for a controlled, uniform seasoning distribution to be achieved with different seasonings and can be used to force seasoning further down the tube. Because the individual segments 104, 106 can be rotated, changing the position of the slot 108, the adjustment gear 112 located on the base member 102, which was previously used to adjust the prior art tubes for proper placement, is only necessary for fine-tuning adjustments of the seasoning tube 100 and is not the only option for adjustment of the seasoning tube 102.

One embodiment of the present invention, shown in FIG. 3, comprises four segments 104 and a terminal segment 106 attached to the base member 102 by sanitary gasket-less clamps 110. The terminal segment 106 is a different length than the other four segments 104, which are of equal length. Each segment 104 and the terminal segment 106 has a slot 108 of about 5.5 to 6.5 inches, preferably about 5.9375 inches in length. The slot 108 of the terminal segment 106 terminates about 1.0 to 1.5 inches, preferably about 1.125 inches from the end of the tube 100. The combined length of the four segments 104 and the terminal segment 106 is about 30 to 40 inches, preferably about 34.544 inches.

Another embodiment of the invention, shown in FIG. 4, comprises two segments 104 and a terminal segment 106 attached to the base member 102 by sanitary gasket-less clamps 110. The two segments 104 and a terminal segment 106 have unequal lengths. The segment 104 attached to the base member 102 and the terminal segment 106 has a slot of about 5.5 to 6.5 inches, preferably about 5.910 inches in length. The segment 104 connecting the segment attached to the base member 102 and the terminal segment 106 has a slot of about 17.5 to 18.5 inches, preferably about 17.730 inches in length, which is offset by 0° to 2°, preferably about 1.10° from the longitudinal axis of the tube 100. The slot 108 of the terminal segment 106 terminates about 1.125 inches from the end of the tube 100. The combined length of the two segments 104 and the terminal segment 106 is about 30 to 40 inches, preferably about 33.779 inches.

The seasoning distribution tube 100 described above may be used in a tumbler seasoning distribution system, like that depicted in FIG. 1, to uniformly distribute seasoning material onto a snack food product. The vertical position of the slots 108 may be adjusted above or below the longitudinal axis of the tube 100 to achieve uniform distribution of the seasoning material along the entire length of the tube 100 or to manipulate the seasoning distribution to specific areas over the length of the tube 100. One skilled in the art may determine the optimum position of the slot 108 for each segment depending on the seasoning used. Snack food product is placed in the tumbler seasoning distribution system and seasoning material is delivered to the tube 100 from the delivery device of the seasoning distribution system and conveyed along the tube 100 by an auger, where the seasoning material is uniformly dispersed from the slots 108 and contacts the snack food product.

### EXAMPLE 1

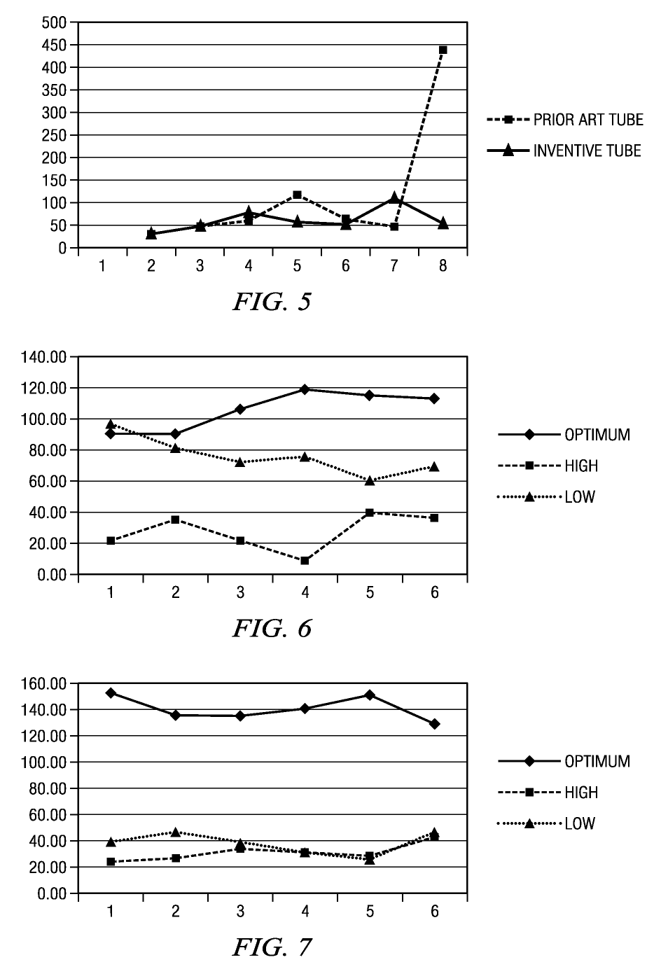

Tests were run with a prior art seasoning tube and the inventive seasoning distribution tube to determine the amount of seasoning distributed at points along the length of the each tube. The delivery device of the seasoning distribution system was filled to approximately 65% capacity with Tostitos® Artisan Recipes™ Roasted Garlic and Black Bean seasoning. Seven collection dishes were placed below each tube along the tube's length. The amount of seasoning in grams collected in each dish over a period of 30 seconds was measured. The amounts collected in each dish are shown below in Table 1. FIG. 5 plots the amounts collected from distribution by the prior art tube and the inventive tube, showing the dish number on the x-axis and amount collected in grams on the y-axis.

TABLE 1
Amount of seasoning collected by prior art tube and inventive tube.

| | Prior Art Tube Amount | Inventive Tube Amount |
|---|---|---|
| Dish No. | (in grams) | (in grams) |
| 1 | 31.8 | 32.00 |
| 2 | 47.30 | 49.90 |
| 3 | 59.80 | 78.10 |
| 4 | 116.50 | 57.00 |
| 5 | 63.80 | 52.70 |
| 6 | 47.50 | 109.50 |
| 7 | 437.50 | 53.70 |

As demonstrated by Table 1 and FIG. 5, the inventive seasoning distribution tube provides a much more uniform distribution of seasoning along the length of the tube compared to the prior art tube which dispersed the majority of its seasoning through the end of the tube.

### EXAMPLE 2

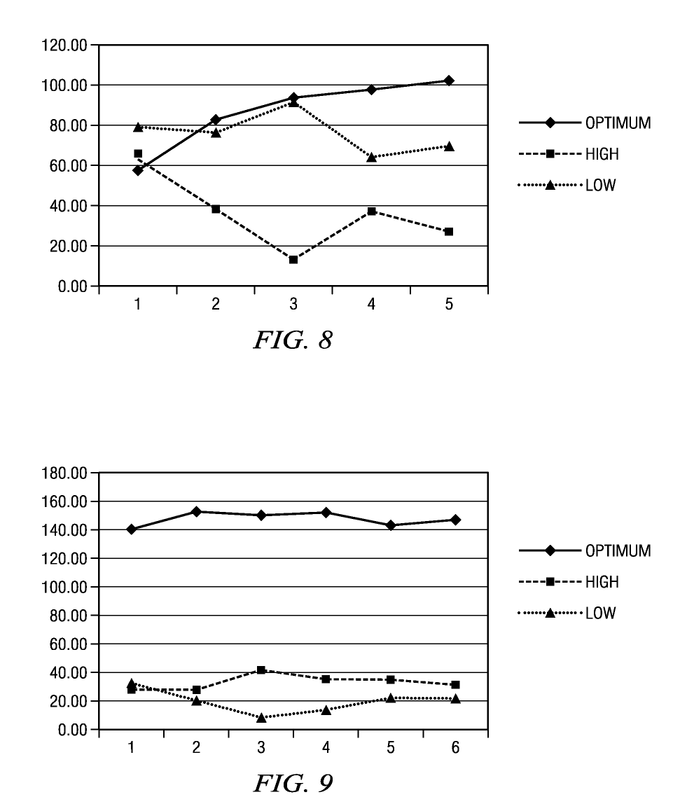

Tests were run with a prior art seasoning tube and the inventive seasoning distribution tube to determine the amount of snack products seasoned within the optimum range, those with unacceptably high levels of seasoning and those with unacceptably low levels of seasoning. Tables 2 and 3 and Graphs 2-5 show the results of these tests. A sample size of approximately 200 grams of product, Doritos® Nacho Cheese Flavored Tortilla Chips, was used for each run. Tables 2 and 3 show the amount of product in grams collected for each run of the prior art tube and the inventive tube that fell within each category—optimum seasoning, unacceptably high seasoning, or unacceptably low seasoning. FIGS. 6 and 8 plot the amount of optimally seasoned product compared to the unacceptably high and unacceptably low seasoned product for the prior art tube. FIGS. 7 and 9 plot the amount of optimally seasoned product compared to the unacceptably high and unacceptably low seasoned product for the inventive tube. The run number is plotted on the x-axis and the amount of product in grams on the y-axis.

TABLE 2
Product coverage at 2378 pounds of seasoning per hour.

| | Prior Art Tube | | | Inventive Tube | | |
|---|---|---|---|---|---|---|
| | Optimum | High | Low | Optimum | High | Low |
| Run No. | Seasoning | Seasoning | Seasoning | Seasoning | Seasoning | Seasoning |
| 1 | 90.02 | 21.41 | 96.40 | 151.48 | 24.02 | 39.32 |
| 2 | 89.78 | 35.12 | 80.66 | 134.31 | 26.74 | 46.18 |
| 3 | 105.35 | 21.23 | 71.61 | 133.61 | 33.34 | 38.66 |
| 4 | 117.75 | 8.99 | 75.02 | 139.18 | 31.01 | 31.78 |
| 5 | 114.10 | 38.97 | 59.97 | 149.20 | 28.12 | 25.82 |
| 6 | 112.38 | 36.19 | 68.98 | 127.67 | 42.53 | 45.96 |

TABLE 3
Product coverage at 1700 pounds of seasoning per hour.

| | Prior Art Tube | | | Inventive Tube | | |
|---|---|---|---|---|---|---|
| | Optimum | High | Low | Optimum | High | Low |
| Run No. | Seasoning | Seasoning | Seasoning | Seasoning | Seasoning | Seasoning |
| 1 | 58.00 | 63.60 | 79.90 | 141.00 | 27.50 | 31.90 |
| 2 | 83.60 | 38.70 | 77.10 | 153.20 | 27.50 | 20.10 |
| 3 | 94.60 | 13.50 | 92.10 | 150.30 | 41.50 | 8.40 |
| 4 | 98.60 | 37.50 | 64.70 | 152.50 | 34.90 | 13.60 |
| 5 | 102.70 | 27.50 | 70.10 | 143.50 | 35.00 | 22.00 |
| 6 | | | | 147.40 | 31.20 | 21.60 |

As shown by Tables 2 and 3 and FIGS. 6-9, the inventive tube results in an increased amount of product having seasoning within the optimum range and reduces the amount of product having unacceptably high or low levels of seasoning.

The instant invention results in a controlled, uniform distribution of seasoning onto a snack food product and can be adapted to an existing product line. There are several advantages with this invention. First, because the amount of seasoning dispersed at each segment can be controlled, seasoning can be forced farther down the tube and uniformly dispersed through each slot and the end of the tube. Less seasoning is lost during the process, resulting in reduced costs. Second, because the seasoning distribution from the tube is more uniform, the product seasoning coverage becomes more uniform. Third, the different flowabilities of different seasonings can be accommodated by adjusting the individual segments. The time it takes for adjustments is generally minutes.

While this invention has been particularly shown and described with reference to a preferred embodiment, it will be understood by those skilled in the art that various changes in form and detail may be made therein without departing from the spirit and scope of the invention.

What is claimed is:

1. An improved seasoning distribution tube for use in a seasoning distribution system having a delivery device, said seasoning distribution tube comprising:
a) a base member wherein one end of said base member is in fluid communication with said delivery device of said seasoning distribution system;
b) at least two segments attached in succession to said base member to form a generally horizontal tube, wherein each of said segments comprises an opening along the length of said segment, and further wherein the vertical position of said opening may be adjusted above or below the longitudinal axis of said horizontal tube.

2. The seasoning distribution tube of claim 1 wherein the segment distal from said base member is a terminal segment and further wherein said opening of said terminal segment terminates about 0.5 to 2.0 from the end of said terminal segment.

3. The seasoning distribution tube of claim 1 wherein said opening is an elongated slot.

4. The seasoning distribution tube of claim 3 wherein said slot has a width of about 0.1 to 1.0 inches.

5. The seasoning distribution tube of claim 1 wherein said segments are attached by sanitary gasket-less design clamps.

6. The seasoning distribution tube of claim 3 comprising three segments.

7. The seasoning distribution tube of claim 3 comprising five segments.

8. The seasoning distribution tube of claim 6 wherein the segment distal from said base member is a terminal segment.

9. The seasoning distribution tube of claim 6 wherein the three segments are of unequal lengths.

10. The seasoning distribution tube of claim 9 wherein the segment attached to said base member and said terminal segment have slots of about 5.5 to about 6.5 inches in length.

11. The seasoning distribution tube of claim 9 wherein the segment connecting said segment attached to said base member and said terminal segment has a slot of about 17.5 to about 18.0 inches in length.

12. The seasoning distribution tube of claim 11 wherein said slot is angled at about 0° to about 2° from the longitudinal axis of said segment.

13. The seasoning distribution tube of claim 6 wherein said three segments have a length of about 30 to about 40 inches.

14. The seasoning distribution tube of claim 7 wherein the segment distal from said base member is a terminal segment.

15. The seasoning distribution tube of claim 7 wherein said terminal segment is a different length than the other four segments.

16. The seasoning distribution tube of claim 7 wherein said slots of said five segments have a length of about 5.5 to about 6.5 inches.

17. The seasoning distribution tube of claim 7 wherein said five segments have a length of about 30 to about 40 inches.

18. The seasoning distribution tube of claim 1 wherein said seasoning distribution tube has a length of about 50 to about 100 inches.

19. The seasoning distribution tube of claim 1 wherein said seasoning distribution tube has a diameter of about 0.5 to about 3.0 inches.

20. The seasoning distribution tube of claim 1 wherein said seasoning distribution tube further comprises an auger within said tube.

21. The seasoning distribution tube of claim 1 wherein said base member further comprises an adjustment gear.

22. An improved seasoning distribution tube for use in a seasoning distribution system having a delivery device, said seasoning distribution tube comprising:
a) a base member wherein one end of said base member is in fluid communication with said delivery device of said seasoning distribution system;
b) at least two segments attached in succession to said base member to form a generally horizontal tube; and
c) a terminal segment attached to said segment distal from said base member, wherein each of said segments and said terminal segment comprise an opening along the length of said segment, and further wherein the vertical position of said opening may be adjusted above or below the longitudinal axis of said horizontal tube.

23. The seasoning distribution tube of claim 22 wherein said opening of said terminal segment terminates about 0.5 to about 2.0 inches from the end of said terminal segment.

24. The seasoning distribution tube of claim 22 wherein said opening is an elongated slot.

25. The seasoning distribution tube of claim 24 wherein said slot has a width of about 0.1 to about 1.0 inches.

26. The seasoning distribution tube of claim 22 wherein said segments are attached by sanitary gasket-less design clamps.

27. The seasoning distribution tube of claim 24 comprising two segments.

28. The seasoning distribution tube of claim 24 comprising four segments.

29. The seasoning distribution tube of claim 27 wherein said segments and said terminal segment are of unequal length.

30. The seasoning distribution tube of claim 29 wherein the segment attached to said base member and said terminal segment have slots of about 5.5 to about 6.5 inches in length.

31. The seasoning distribution tube of claim 29 wherein the segment connecting said segment attached to said base member and said terminal segment has a slot of about 17.5 to about 18.0 inches in length.

32. The seasoning distribution tube of claim 31 wherein said slot is angled at about 0° to 2° from the longitudinal axis of said segment.

33. The seasoning distribution tube of claim 27 wherein said two segments and said terminal segment have a combined length of about 30 to about 40 inches.

34. The seasoning distribution tube of claim 28 wherein said terminal segment is a different length than said four segments.

35. The seasoning distribution tube of claim 28 wherein said slots of said four segments and said terminal segment have a length of about 5.5 to about 6.5 inches.

36. The seasoning distribution tube of claim 28 wherein said four segments and said terminal segment have a combined length of about 30 to about 40 inches.

37. The seasoning distribution tube of claim 22 wherein said seasoning distribution tube has a length of about 50 to about 100 inches.

38. The seasoning distribution tube of claim 22 wherein said seasoning distribution tube has a diameter of about 0.5 to about 3.0 inches.

39. The seasoning distribution tube of claim 22 wherein said seasoning distribution tube further comprises an auger within said tube.

40. The seasoning distribution tube of claim 22 wherein said base member further comprises an adjustment gear.

41. A method for uniformly distributing seasoning material onto a snack food product, said method comprising the steps of:
a) providing the tube of claim 1;
b) adjusting the vertical position of said openings of said segments above or below the longitudinal axis of said tube to achieve uniform distribution of said seasoning material along the length of said tube;
c) placing said snack food product in said seasoning distribution system;
d) delivering said seasoning material to said tube from said delivery device; and
e) contacting said snack food product with said seasoning material.
